(19) United States
(12) Patent Application Publication
(10) Pub. No.: US 2009/0211524 A1
(43) Pub. Date: Aug. 27, 2009

(54) Sprinicling Head and Method for Sprinkling Powder Patterns on a Transparent Plate; For Preparing a Relief Glass Substrate With a Durable Coloured Pattern

(76) Inventors: Gerardus Titus Van Heck, Eindhoven (NL); Stijn Ruud Louis Berden, Valkenswaard (NL); Merijn Wijnen, Eindhoven (NL); Renè Jos Houben, Nedenweert (NL)

Correspondence Address: MICHAELSON & ASSOCIATES, P.O. BOX 8489, RED BANK, NJ, 07701-8489, US

(21) Appl. No.: 12/085,493

(22) PCT Filed: Nov. 28, 2006
(86) PCT No.: PCT/NL2006/000596

§ 371 Date: Mar. 12, 2009

(30) Foreign Application Priority Data
Nov. 29, 2005 (EP) 05077731.7

(51) Int. Cl. B05C 19/06; B05C 19/04; B05C 5/00

(52) U.S. Cl. 118/699; 118/308; 118/310

(57) ABSTRACT

Sprinkling head (2) for sprinkling powder (4) on a glass plate (6). The sprinkling head comprises a frame (8) and one or more delivering devices (16) for delivering a powder to the transparent plate. The one or more delivering devices are mechanically coupled to the frame and comprise: a container (17) for containing a pigmented powder; an outlet unit (20) for delivering the power onto the transparent plate, the outlet unit comprising an opening (22) through which the powder is delivered onto the transparent plate; a vibratable feed channel (26) for feeding the powder from the container to the outlet unit when the feed channel is in a vibrational state, in which state the feed channel vibrates with respect to the frame so that the powder is sprinkled, via the opening, onto the plate, and an actuator (28) for bringing the feed channel into the vibrational state.

The invention relates to a sprinkling head for sprinkling powder on a transparent plate, more specifically a glass plate, and a sprinkling apparatus comprising such a sprinkling head. Furthermore, the invention relates to use of such a sprinkling head and/or sprinkling apparatus for preparing a relief glass substrate with a durable colored pattern.

A sprinkling device is known from an article entitled ‘The Sand Painter: TwoDimensional Powder Deposition’ by Joseph Pegna et al. from Solid Freeform Fabrication Proceedings, 1999, pp 695-710. The known sprinkling device is formed by a body having a powder-containing part, a substantially horizontal part and a vertical end part having a mouth piece, the horizontal part being located between the end part and the powder containing part. In order to transfer the powder from the powder-containing part to the vertical end through the horizontal part in a well-dosed manner, the body is brought to a vibrational state.

After using the device for sprinkling powder on a glass plate, a relief glass substrate can be formed in a manner described in European patent application 04076932.5 (unpublished) filed on Jul. 5, 2004 at the European Patent Office.

An disadvantage of the known device is using the device is both time and power consuming. A further disadvantage is that it is and rather inaccurate.

An object of the present invention is to address the disadvantages mentioned above. In accordance with an object of the invention, there is provided a sprinkling head for sprinkling powder on a transparent plate, more specifically a glass plate the sprinkling head comprising a frame and one or more delivering devices for delivering a powder to the transparent plate, the delivering devices being mechanically coupled to the frame, the one or more devices comprising a container for containing a pigmented powder; an outlet unit for delivering the power onto the transparent plate, the outlet unit comprising an opening through which the powder is delivered onto the transparent plate; a vibratable feed channel for feeding the powder from the container to the outlet unit when the feed channel is in a vibrational state, in which state the feed channel vibrates with respect to the frame so that the powder is sprinkled, via the opening, onto the plate, and an actuator for bringing the feed channel into the vibrational state.

In this way, only the feed channel, instead of the complete sprinkling device, needs to be in the vibrational state, which significantly reduces the power required for operation of the sprinkling head. Furthermore, because the rest of the sprinkling head can remain in a relatively stationary state, the accuracy of the sprinkling head may be significantly improved.

In an embodiment of the sprinkling head according to the present invention, the feed channel is comprised in a feed unit comprising a rigid body. The rigid body may comprise a clamped part and a vibratory part, wherein the vibratory part comprises at least a portion of the feed channel and wherein the vibratory part has a predetermined length for establishing a resonance frequency of the feed channel. An advantage of this embodiment is the fact that the actuator may bring the feed channel into the vibrational state at the resonance frequency, which even further minimizes the amount of power required when the sprinkling head is in operation.

In order to be able to sprinkle different colors and combinations of colors using just one sprinkling head, an advanced embodiment of the sprinkling head may comprise a plurality of delivering devices. However, in such an embodiment it is preferred that the plurality of delivering devices comprise a plurality of feed channels, respectively, wherein the plurality of feed channels each have a different resonance frequency, respectively, so that interference due to vibrations in different devices is minimized. Also, for minimizing interference, it is preferred that a vibrational decoupling is provided between the plurality of feed channels. To this end, at least one vibration absorbing element is provided between the plurality of feed channels for establishing the decoupling. Such vibration absorbing elements may be substantially formed of a rubber material.

In a particular embodiment of the sprinkling apparatus according to the present invention, the sprinkling head comprises at least three delivering devices. The three containers of the devices may be provided with red, blue and yellow pigmented powders respectively. Using these three pigmented powders, other colors can be derived by way of mixing these powders.

In an embodiment of the sprinkling head according to the present invention, the container is detachably mounted to the delivering device, which has the advantage that empty containers can be removed in their entirety and be replaced with filled ones. It is therefore not required to refill an empty container, which is a more time-consuming task and may involve spilling of powder.

In a preferred embodiment of the sprinkling apparatus according to the present invention, the sprinkling apparatus comprises a retaining surface for retaining the transparent plate. By providing the apparatus with such a retaining surface, a stable surface on which to place the plate is provided and, thus, a good quality of a powder-sprinkled plate is ensured.

A convenient way in which to move the sprinkling head relative to the transparent plate is by providing the sprinkling apparatus with a first mechanical guide for guiding movement of the sprinkling head with respect to the transparent plate along an X-axis of the plate. Also, the sprinkling apparatus can be provided with a second mechanical guide for guiding movement of the first mechanical guide with respect to the transparent plate along a Y-axis of the plate.

Preferably, the sprinkling apparatus is provided with a central control unit arranged to bring the feed channel in the vibrational state by controlling the actuator. The central control unit may further be arranged to control movement of the sprinkling head with respect to the transparent plate. The central control unit can further be arranged to bring the apparatus to a first sprinkling state by bringing the feed channel in the vibrational state when the sprinkling head moves in a predetermined first direction. Also, the central control unit may be arranged to bring the apparatus to a second sprinkling state by bringing the feed channel in the vibrational state when the sprinkling head moves in a predetermined second direction extending in a direction opposite to the first direction. Moreover, the central control unit can advantageously be arranged to bring the apparatus in an alternating manner to the first and the second sprinkling state. This has the advantage that the sprinkling apparatus is in a sprinkling state most of the time during operation.

However, in order to compensate for poor alignment of lines sprinkled during movement in the first direction with respect to lines sprinkled during movement in the second direction, the central control unit may be arranged for alignment by application of a time interval between a start of the movement in the first direction and a start of activating the actuator for bringing the feed channel into the vibrational state.

In order to provide a sprinkling apparatus which is energy efficient, the central control unit is preferably arranged to control the actuator to vibrate the feed channel at a resonance frequency.

However, a further, important advantage of providing a sprinkling apparatus in which the central control unit is arranged to control the actuator to vibrate the feed channel at a non-resonant frequency, is that such an arrangement allows for a large tolerance in frequency.

These and other aspects of the invention will be apparent from and elucidated with reference to the embodiments described hereinafter with reference to the accompanying drawing. Herein,

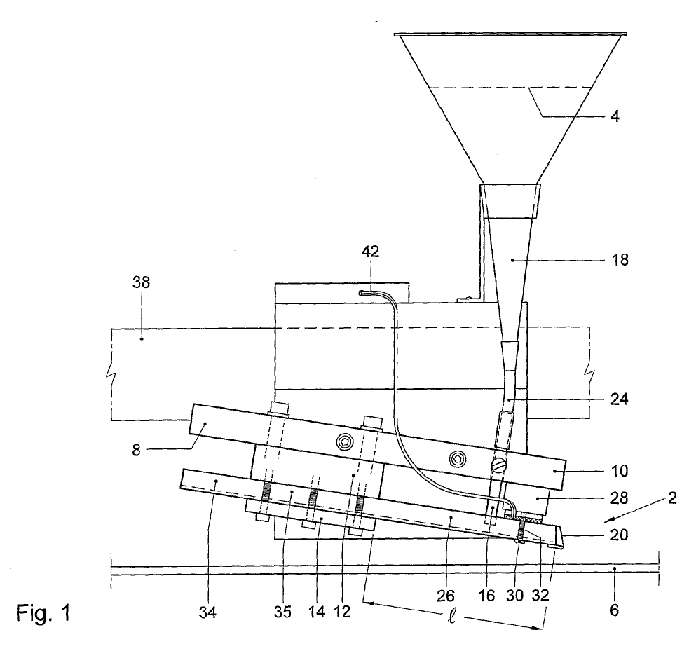

FIG. 1 is a side view of a first embodiment of the sprinkling head according to the present invention;

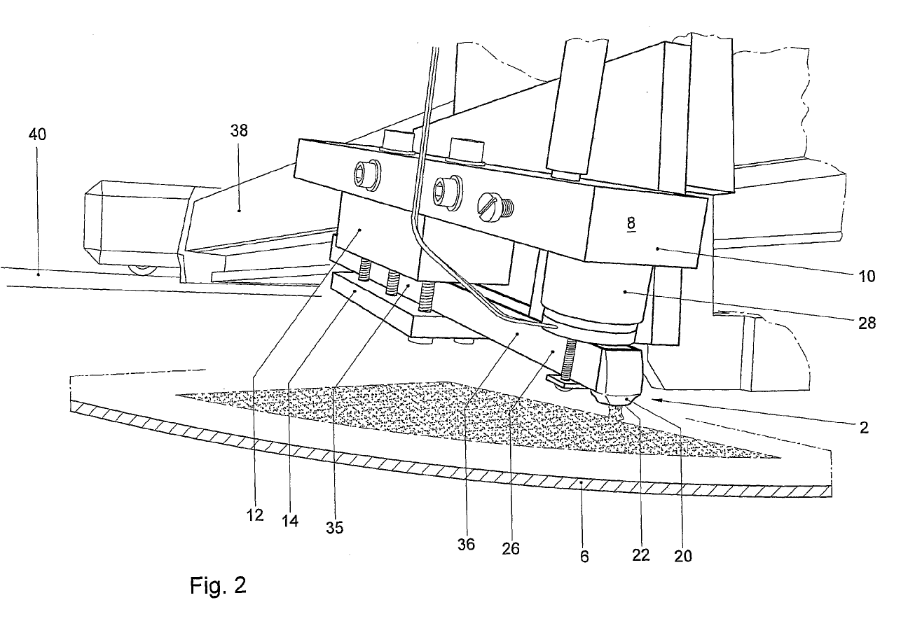

FIG. 2 is a perspective view of the sprinkling head of FIG. 1 while in operation;

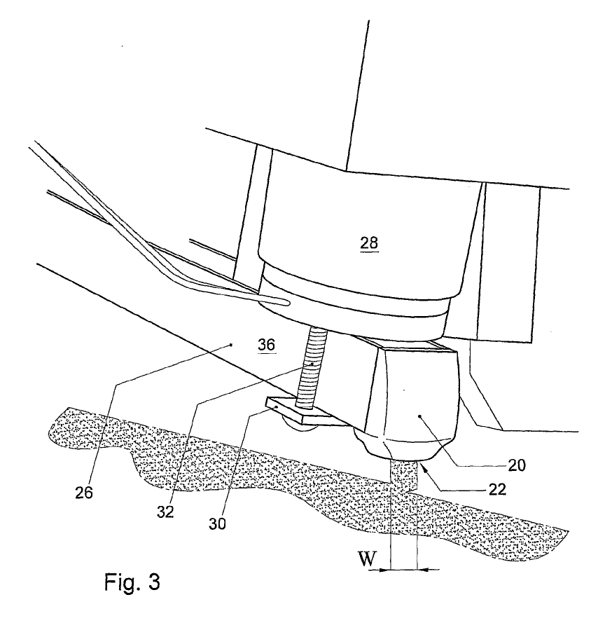

FIG. 3 is a detailed perspective view of a part of the sprinkling head of FIG. 1;

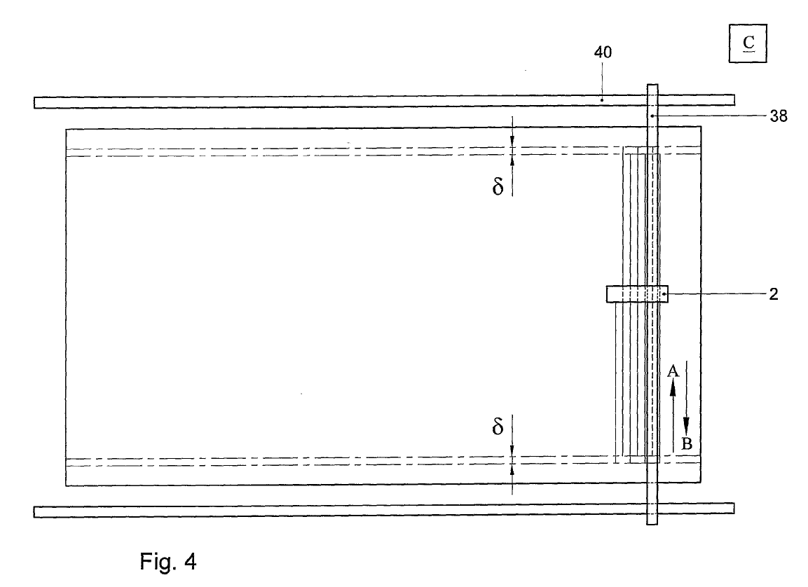

FIG. 4 is a schematic top view of a sprinkling apparatus comprising the sprinkling head of FIG. 1;

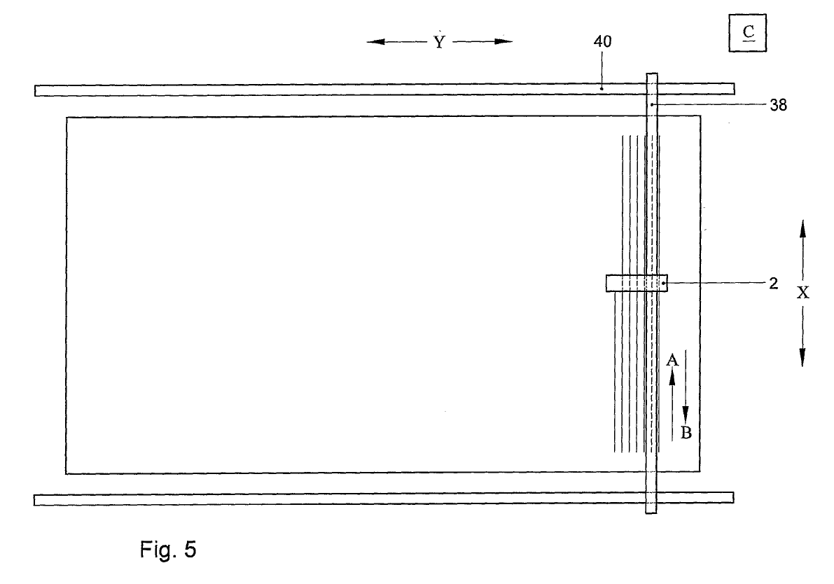

FIG. 5 is a schematic top view of a modification of the sprinkling apparatus comprising the sprinkling head of FIG. 1;

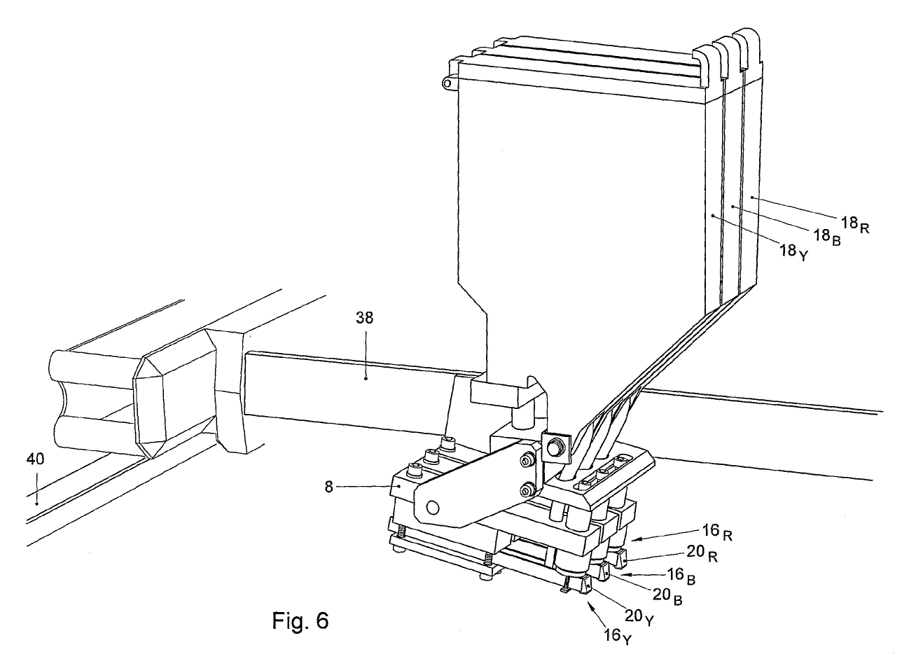

FIG. 6 is a perspective view of a second embodiment of the sprinkling head according to the present invention;

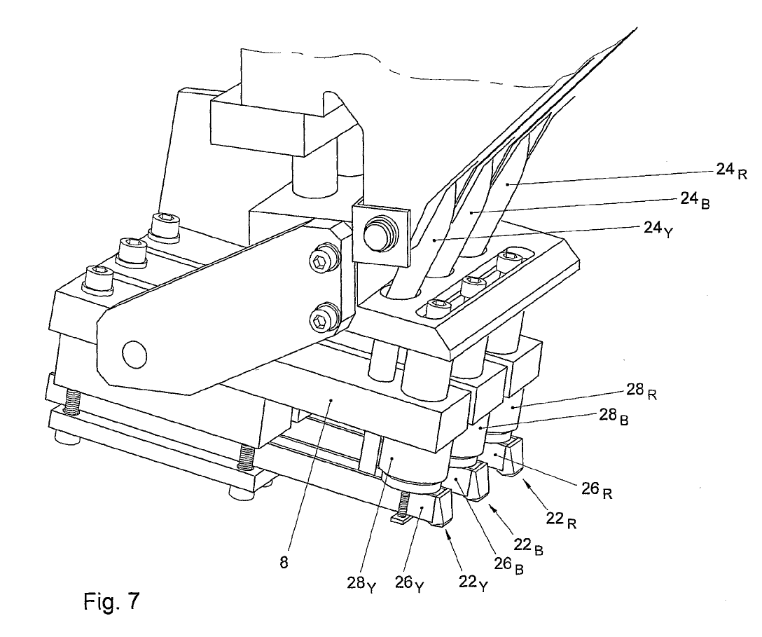

FIG. 7 is a detailed perspective view of a part of the sprinkling head of FIG. 6;

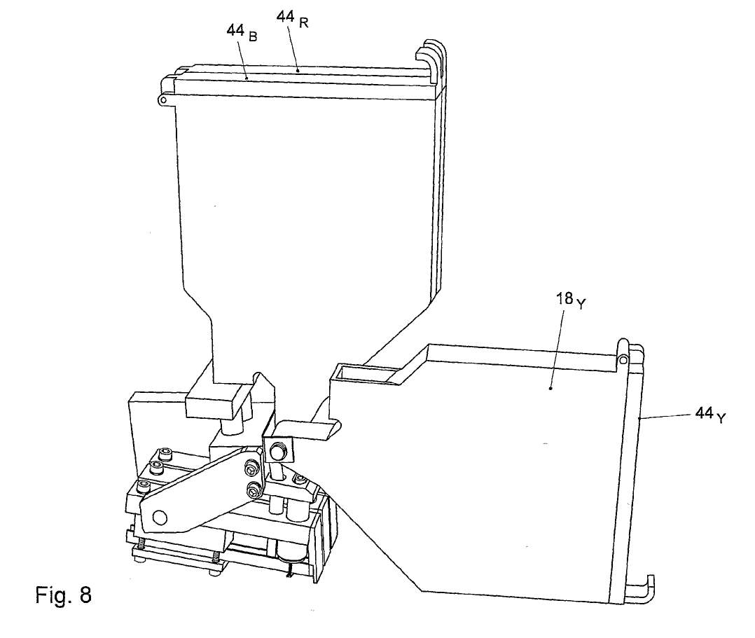

FIG. 8 is another view of the sprinkling apparatus of FIG. 6 with a container in a tilted state, and

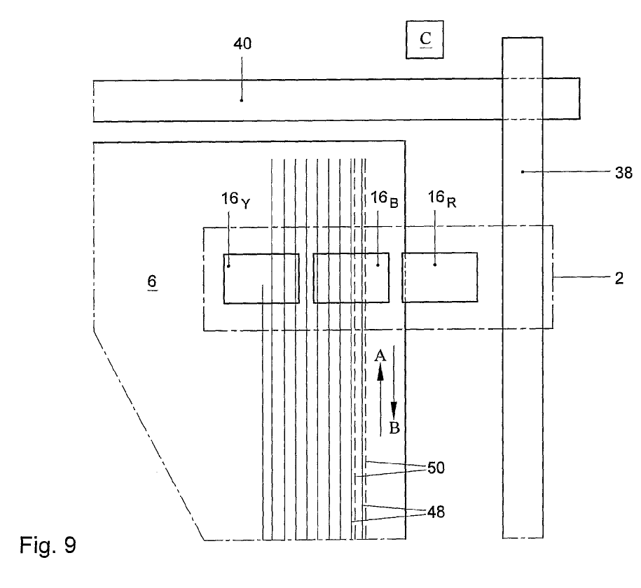

FIG. 9 is a schematic top view of a sprinkling apparatus comprising the sprinkling head of FIG. 6.

Referring to FIGS. 1, 2 and 3, a first embodiment of the sprinkling head 2 for sprinkling a pigmented powder 4 on a glass plate 6 is disclosed. The sprinkling head 2 is comprised in a sprinkling apparatus. The sprinkling head comprises a frame 8 having a main part 10, first and second block parts 12 and 14 arranged to clamp an object between them and one or more delivering devices 16 for delivering the powder 4 to the glass plate 6. The one or more delivering devices are mechanically coupled to the frame. In one embodiment, the one or more delivering devices are attached to the frame 8. The one or more delivering devices 16 comprise a funnel 18 that serves as a container for retaining the powder 4. The dotted line in FIG. 1 indicates the level of the powder 4 in the funnel 18. The delivering device 16 also has an outlet unit 20 with an opening 22 through which the powder 4 is delivered onto the glass plate 6, the opening 22 having a predetermined width w. Furthermore, the funnel 18 comprises a chute 24 and the delivering device 16 comprises a vibratory feed channel 26 which, in this embodiment of the sprinkling head 2, extends in a substantially horizontal direction. The chute 24 extends to the feed channel 26 for guiding the powder 4 from the funnel 18 to the feed channel 26. Moreover, the delivering device 16 comprises an actuator 28 for bringing the feed channel 26 into the vibrational state. In this embodiment the actuator 28 is a linear Lorentz actuator, more specifically a moving coil actuator, and is mounted on the main part 10 of the frame 8. In this embodiment, the actuator 28 is clamped to the feed channel 26 by way of a clamping plate 30 and two clamping screws 32 (of which only one is shown in the Figures) such that, when the actuator is in operation, the feed channel 26 vibrates with respect to the frame 8.

In this embodiment of the sprinkling apparatus, the feed channel 26 is part of an elongated, rigid body 34. This body 34 comprises a clamped part 35 which is clamped between the block parts 12, 14 of the frame 8 by means of six screws of which three can be easily seen in FIGS. 1 and 2. The body 34 further comprises a vibratory part 36, wherein the vibratory part 36 contains at least a portion of the feed channel 26 and wherein the vibratory part 36 has a length l. The length l predetermined so that a resonance frequency of the feed channel 26 can be established.

For moving the sprinkling head 2 along the surface of the plate 6, the sprinkling apparatus is provided with a first mechanical guide 38 for guiding movement of the sprinkling head 2 with respect to the glass plate 6 along an X-axis of the plate 6. As can be seen in FIG. 2, the first embodiment of the sprinkling apparatus is provided with a second mechanical guide 40 for guiding movement of the first mechanical guide 38 with respect to the glass plate 6 along a Y-axis of the plate 6, the X-axis and the Y-axis being substantially perpendicular to each other. Also, the sprinkling apparatus comprises a first and a second drive (not shown in the Figures) for moving the sprinkling head 2 along X-axis and the first mechanical guide along the Y-axis.

Furthermore, the sprinkling apparatus is provided with a central control unit C (see FIGS. 4 and 5) arranged to bring the feed channel 26 in the vibrational state by controlling the actuator 28 through wiring 42 and to control the movement of the sprinkling head 2 with respect to the plate 6 by controlling the first and the second drive.

The sprinkling apparatus works as follows. By controlling the first and the second drive, the central control unit C controls the movement of the sprinkling head 2, including the container which is filled with the powder 4 to a starting point from which the sprinkling of the powder 4 is to commence. At this stage the feed channel 26 is in a non-vibrational state. The powder 4 in the funnel 18 is located in the chute 24 and in the feed channel 26. However, since the feed channel 26 is not in the vibrational state, the powder may not move through the feed channel 26 towards the outlet unit 20 and thus no powder is spilled onto the plate 6 unintentionally For starting the sprinkling of the powder 4 onto the plate 6, the central control unit C brings the sprinkling apparatus to a first sprinkling state. In order to do so, the control unit C sends an alternating current signal through the wiring 42 to actuator 28 so that the feed channel 26 is brought to the vibrational state and moves the sprinkling head 2 guided by the first mechanical guide 38 in a first direction A along the X-axis (see FIGS. 4 and 5). Due to the vibrations in the feed channel 26, the powder 4 moves through the feed channel 26 to the outlet unit 20. The powder 4 then falls through the opening 22 and a line 43 is thus sprinkled onto the plate 6. The control unit C may be arranged to control the amount of powder 4 sprinkled onto the plate 6, when the sprinkling apparatus is in the first sprinkling state by controlling the amplitude of the vibrations or the speed of the movement of the sprinkling head 2.

When the sprinkling head 2 has reached a predetermined farthest position, the central control unit C stops sending the alternating current through the wiring 42, so that the actuator 28 and stops vibrating the feed channel 26. Also the movement along the X-axis stops. Subsequently, using the second mechanical guide 40 the central control unit C moves the first mechanical guide 38 over a distance substantially equal to the width w of the opening 22.

Hereafter, the sprinkling apparatus is brought to a second sprinkling state. In order to do so, the feed channel 26 is again brought to the vibrational state and the central control unit C moves the sprinkling head 2 in a second direction B along the X-axis extending in a direction opposite to the first direction A. As in the first sprinkling state, the control unit C may be arranged to control the amount of powder 4 sprinkled onto the plate 6, when the sprinkling apparatus is in the second sprinkling state, by controlling the amplitude of the vibrations or the speed of the movement of the sprinkling head 2.

When the sprinkling head 2 again has reached another predetermined farthest position, the central control unit C stops sending the alternating current through the wiring 42, so that the actuator 28 again stops vibrating the feed channel 26. Also the movement in the second direction B stops. Again, using the second mechanical guide 40 the central control unit C moves the first mechanical guide 38 over the distance having the width w of the opening 22.

The operation disclosed hereabove can be repeated as often as necessary. Also, during movement in the first and/or second directions, it may be desired to temporarily interrupt vibration while maintaining movement, to form a predetermined pattern of the plate 6.

When the desired coverage of the plate 6 has been reached, the plate 6 can be placed on a mould and be exposed to a temperature high enough for firing the pigmented powder in order to prepare a relief glass substrate with a durable colored pattern. This method is described in European patent application 04076932.5 (unpublished) filed on Jul. 5, 2004, by the ‘Nederlandse Organisatie voor toegepast-natuurwetenschappelijk onderzoek’, at the European Patent Office.

Referring to FIG. 4, it has been found that lines sprinkled by sprinkling heads may not be aligned. A non-alignment may be caused by a discrepancy between the moment at which the feed channel is brought into the vibrational state, on the one hand, and the moment at which the sprinkling of the powder 4 is commenced. Therefore, if the feed channel is brought to the vibrational state at the same moment that the movement in the first direction A commences, there may be a distance over which no powder 4 will be sprinkled, causing a shift 6 in the first direction A. Where the powder 4 is alternatingly sprinkled in the first and second directions A, B, the shift 6 may be alternatingly present in both directions, as can be schematically seen in FIG. 4. This effect may cause a distortion in the quality of the patterns to be sprinkled onto the plate 6. Thus, in a further embodiment, the central control unit C is arranged to control the sprinkling head for alignment of the lines sprinkled during movement in the first direction with respect to lines sprinkled during movement in the second direction. This may, for example, be achieved by application of a time interval between a start of the movement in the first direction and a start of activating the actuator for bringing the feed channel into the vibrational state. In this way, a disalignment, as illustrated in FIG. 4, is overcome. For example, can be schematically seen in FIG. 5, the result is an improved alignment between the lines sprinkled in the first direction and lines sprinkled in the second direction.

Referring to FIGS. 6, 7, 8 and 9, a second embodiment of the sprinkling head 2 according to the present invention is described. The second embodiment of the present invention differs from the first embodiment in that the sprinkling head 2 comprises, at least three, in particular, three delivering devices 16_{R}, 16_{B} and 16_{Y}. Each of these devices 16_{R,B,Y} comprises a container 18_{R,B,Y} for containing a pigmented powder 4_{R,B,Y}, each of these containers 18_{R,B,Y} comprising a chute 24_{R,B,Y} and a box with a lid 44_{R,B,Y}. As can be seen in FIG. 8 the lid 44_{R,B,Y} is rotatable with respect to the frame 8 to facilitate emptying the container. Each of the devices 16_{R,B,Y} further contains an outlet unit 20_{R,B,Y} comprising an opening 22_{R,B,Y} through which the powder 4_{R,B,Y} is delivered to the glass plate 6. Between the openings 22_{R} and 22_{B} and openings 22_{B} and 22_{Y} respectively, a distance of 7 w is provided, w being the width of each of the individual openings. Moreover, each of the delivering devices 16_{R,B,Y} has a vibratable feed channel 26_{R,B,Y} for feeding the powder from the container to the outlet unit. The feed channel 26_{R,B,Y} feeds the powder to the outlet unit 20_{R,B,Y} when the feed channel 26_{R,B,Y} is in a vibrational state, in which state the feed channel vibrates with respect to the frame 8 such that the powder is sprinkled, via the opening 22_{R,B,Y} onto the plate. In order to bring the feed channel into the vibrational state an actuator 28_{R,B,Y} is furthermore provided in each of the delivering devices 16_{R,B,Y}. In the second embodiment of the sprinkling head 2 each of the containers 18_{R,B,Y} comprises a different color. A first container 18_{R} comprises a red pigmented powder 4_{R}, a second container 18_{B} comprises a blue 4_{B} pigmented powder and a third container 18_{Y} comprises a yellow pigmented powder 4_{Y}.

Each of the actuators 28_{R,B,Y} is, in this embodiment, coupled to only one of the feed channels 26_{R,B,Y}. In this embodiment a first actuator 28_{R} is coupled to first feed channel 26_{R}, a second actuator 26_{B} is coupled to second feed channel 26_{B} and a third actuator 26_{Y} is coupled to a third feed channel 26_{y}. To prevent vibrations of, for instance, a second actuator 28_{B} from influencing the state of feed channels 26_{R} and 26_{Y}, or at least reduce this influence, the frame 8 of the sprinkling head 2 is provided with a vibrational decoupling, in this embodiment formed by two vibration absorbing rubber elements 46.

As is the case in the first embodiment, in this embodiment of the sprinkling apparatus, the feed channels 26_{R,B,Y} are each part of an elongated, rigid body 34_{R,B,Y}. This body 34_{R,B,Y} comprises a clamped part 36_{R,B,Y} which is clamped between the block parts 12, 14 of the frame 8 by means of a number of screws. The body 34_{R,B,Y} further comprises a vibratory part 36_{R,B,Y,} the vibratory part 36_{R,B,Y} containing at least a portion of the feed channel 26_{R,B,Y} and the vibratory part 36_{R,B,Y} having a length l. The length l is predetermined so that a resonance frequency of each of the feed channels 26_{R,B,Y} can be set, each feed channel 26_{R,B,Y} being actuated by its respective actuator 28_{R,B,Y} at its resonance frequency. In order to further prevent vibrations of an actuator from influencing the vibrational state of more than one of the feed channels 26_{R,B,Y} or at least reduce this influence, the resonance frequencies of each of the feed channels 26_{R,B,Y} differ from each other.

The second embodiment of the sprinkling head 2 can be used as part of the sprinkling apparatus provided with the first mechanical guide 38 for guiding a movement of the sprinkling head with respect to the transparent plate along an X-axis of the plate and the second mechanical guide 40 for guiding a movement of the first mechanical guide 38 with respect to the transparent plate along a Y-axis of the plate.

Furthermore, the sprinkling apparatus is provided with a central control unit C (see FIG. 9) arranged to bring the feed channel in the vibrational state by controlling the actuators 28_{R,B,Y}. Also, the central control unit C is furthermore arranged to bring the apparatus to a second sprinkling state by bringing the feed channel in the vibrational state when the sprinkling head moves in a predetermined second direction opposite to the first direction.

Operation of the second embodiment is similar to operation of the first embodiment. Operation of the second embodiment is illustrated in FIG. 9, in which solid lines 48 represent yellow lines sprinkled by the third delivering device 16_{Y} and dashed lines 50 represent blue lines sprinkled by the second delivering device 16_{B}. However, as is illustrated by FIG. 9, operation is started using only the third delivering device 16_{Y}. Using this delivering device 16_{Y}, the sprinkling head 2 is moved back and forth in the first and second direction while being brought to a first sprinkling state and a second sprinkling state respectively. When the ninth line is being sprinkled onto the plate 6, the second delivering device 16_{B} is used. The distance between the openings 22_{Y} and 22_{B} is such that first line sprinkled by the first delivering device 16_{B} coincides with the ninth line sprinkled by the second delivering device 16_{Y}. In analogy, the distance between the openings 22_{B} and 22_{R} is such that first line sprinkled by the first delivering device 16_{R} coincides with the ninth line sprinkled by the second delivering device 16_{B} and thus with the seventeenth line sprinkled by the third delivering device 16_{Y}. It is noted that a skilled person will acknowledge that the blue line 50 is sprinkled on top of the yellow line in reality and that these lines are drawn as adjacent lines for illustrative reasons only.

During the firing process disclosed in (unpublished) European patent application 04076932.5, the different powders mix so that a wide palette of different colors is at the user's disposal.

A person skilled in the art will appreciate that the scope of the present invention is not limited to the embodiments disclosed herein. It is, for instance not required that the feed channel extends in a substantially horizontal position as in the embodiments shown. Furthermore, an embodiment of the printing head according to the present invention in which the outlet unit is integrated with the feed channel is also understood to be inside the scope of the present invention as defined by the accompanying claims.

1: Sprinkling head for sprinkling powder on a transparent plate, more specifically a glass plate, the sprinkling head comprising a frame and one or more delivering devices for delivering a powder to the transparent plate, the delivering devices being mechanically coupled to the frame, the one or more devices comprising: a container for containing a pigmented powder; an outlet unit for delivering the power onto the transparent plate, the outlet unit comprising an opening through which the powder is delivered onto the transparent plate; a vibratable feed channel comprised in a rigid body, the vibratable feed being arranged to feed the powder from the container to the outlet unit when the feed channel is in a vibrational state, wherein the vibratory part comprises at least a portion of the feed channel; and an actuator for bringing the feed channel into the vibrational state, wherein the frame is arranged to clamp a clamped part of the vibratable feed channel, so that in the vibrational state the feed channel vibrates with respect to the frame, so that the powder is sprinkled, via the opening, onto the plate.

2: Sprinkling head according to claim 1, wherein the feed channel extends in a substantially horizontal direction.

3: Sprinkling head according to 1, wherein the container comprises a chute for guiding the powder to the feed channel.

4: Sprinkling head according to claim 1, wherein the body is elongated.

5: Sprinkling head according to claim 1, wherein a length of the vibratory part of the rigid body is predetermined for establishing a resonance frequency of the feed channel.

6: Sprinkling head according to claim 1, comprising a plurality of delivering devices.

7: Sprinkling head according to claim 6, wherein the plurality of delivering devices comprise a plurality of feed channels, respectively, wherein the plurality of feed channels each have a different resonance frequency, respectively.

8: Sprinkling head according to claim 6, wherein a vibrational decoupling is provided between the plurality of feed channels.

9: Sprinkling head according to claim 8, wherein at least one vibration absorbing element is provided between the plurality of feed channels for establishing the decoupling.

10: Sprinkling head according to claim 9, wherein the at least one vibration absorbing element is substantially formed of a rubber material.

11: Sprinkling head according to claim 6, comprising at least three delivering devices.

12: Sprinkling head according to claim 1, wherein the pigment powder is a red, blue or yellow.

13: Sprinkling head according to claim 12 wherein the at least three delivering devices comprise at least three containers, respectively, wherein the at least three containers are provided with red, blue and yellow pigmented powders, respectively.

14: Sprinkling head according to claim 1, wherein the actuator is a linear Lorentz actuator, such as a moving coil actuator.

15: Sprinkling head according to claim 1, wherein the container is detachably mounted to the delivering device.

16: Sprinkling apparatus for sprinkling powder patterns on a transparent plate, more specifically a glass plate, wherein the sprinkling apparatus comprises a sprinkling head according to claim 1.

17: Sprinkling apparatus according to claim 16, wherein the sprinkling apparatus comprises a retaining surface for retaining the transparent plate.

18: Sprinkling apparatus according to claim 16, wherein the sprinkling apparatus is provided with a first mechanical guide for guiding movement of the sprinkling head with respect to the transparent plate along an X-axis of the plate.

19: Sprinkling apparatus according to claim 18, wherein the sprinkling apparatus is provided with a second mechanical guide for guiding movement of the first mechanical guide with respect to the transparent plate along a Y-axis of the plate.

20: Sprinkling apparatus according to claim 19, wherein the X-axis and the Y-axis are substantially perpendicular to each other.

21: Sprinkling apparatus according to claim 16, wherein the sprinkling apparatus is provided with a central control unit arranged to bring the feed channel in the vibrational state by controlling the actuator.

22: Sprinkling apparatus according to claim 21, wherein the central control unit is further arranged to control movement of the sprinkling head with respect to the transparent plate.

23: Sprinkling apparatus according to claim 21, wherein the central control unit is further arranged to bring the apparatus to a first sprinkling state by bringing the feed channel in the vibrational state when the sprinkling head moves in a predetermined first direction.

24: Sprinkling apparatus according to claim 23, wherein the central control unit is further arranged to bring the apparatus to a second sprinkling state by bringing the feed channel in the vibrational state when the sprinkling head moves in a predetermined second direction extending in a direction opposite to the first direction.

25: Sprinkling apparatus according to claim 24, wherein the central control unit is arranged to bring the apparatus in an alternating manner to the first and the second sprinkling state.

26: Sprinkling apparatus according to claim 25, wherein the central control unit is arranged for alignment of lines sprinkled during movement in the first direction with respect to lines sprinkled during movement in the second direction.

27: Sprinkling apparatus according to claim 26, wherein the central control unit is arranged for alignment by application of a time interval between a start of the movement in the first direction and a start of activating the actuator for bringing the feed channel into the vibrational state.

28: Sprinkling apparatus according to claim 16, wherein the central control unit is arranged to control the actuator to vibrate the feed channel at a resonance frequency.

29: Sprinkling apparatus according to claim 16, wherein the central control unit is arranged to control the actuator to vibrate the feed channel at a non-resonant frequency.

30: Use of a sprinkling head according to claim 1 for preparing a relief glass substrate with a durable colored pattern.

31: Use of a sprinkling apparatus according to claim 16 for preparing a relief glass substrate with a durable colored pattern.
